(19) United States
(12) Patent Application Publication
(10) Pub. No.: US 2007/0293222 A1
(43) Pub. Date: Dec. 20, 2007

(54) Mobile Communications With Unlicensed-Radio Access Networks

(76) Inventors: Jari Tapio Vikberg, Jarna (SE); Tomas Nylander, Varmdo (ES)

Correspondence Address: ERICSSON INC., 6300 LEGACY DRIVE, M/S EVR 1-C-11, PLANO, TX, 75024, US

(21) Appl. No.: 10/597,955

(22) PCT Filed: Feb. 18, 2004
(86) PCT No.: PCT/EP04/01540

§ 371 Date: May 10, 2007

(51) Int. Cl. H04Q 7/20

(52) U.S. Cl. 455/436

(57) ABSTRACT

An unlicensed-radio access network is proposed for communication with a mobile terminal and packet service nodes in a core network portion of a mobile telecommunications network. The access network comprises local base stations each defining a mini-cell and adapted to communicate with mobile terminals over an unlicensed-radio interface and an access network controller connected to the local base stations and to a packet service node in the core network portion. The mini-cells are also grouped into at least two packet service cells. The local base stations that generate these mini-cells are assigned a cell identifier comprising a first identifier portion that is common for all local base stations connected to the access network controller and a second identifier portion that is different for local base stations in different packet service cells but common for all local base stations in the same packet service cell.

### FIELD OF INVENTION

The invention concerns mobile communication combining both public mobile access networks and unlicensed access networks. The invention has specific relevance to the use of packet services over licensed radio mobile networks using unlicensed-radio access networks.

### BACKGROUND ART

In any mobile communication system, such as a GSM network active calls conducted between a mobile station and a base station need to be handed over to a different base station as the mobile station moves between different coverage areas, or cells. Depending on how each cell is defined, handover may require the active call to be re-routed simply through a different base station tranceiver BTS, through a different base station controller BSC or through a different mobile services switching center MSC—or when the General Packet Radio Service (GPRS) is supported by the network through a different GPRS support node SGSN. Handover may also be necessary when capacity problems are met in any one cell.

Handover necessitates a certain amount of operation and maintenance, such as defining neighbouring cells, as well as the base station controller BSC and mobile services switching center MSC or GPRS support node SGSN that controls the cell, defining which cell frequencies should be measured and what threshold value to use to initiate handover. In a conventional GSM network the base station controller BSC sends a mobile station a list of frequencies to be measured. Two lists may be sent out, a first list being used for idle mode, such as when the mobile station is roaming, and a second used for active mode when a call is ongoing. This second list defines which frequencies the mobile station should measure and report back on. These lists contain a set of values that refer to absolute radio frequency channel numbers ARFCN of neighbouring cells. In addition to these frequency channel numbers the base station controller BSC also knows base station identity codes BSIC of all neighbouring cells. The mobile station measures the frequencies defined by these channel numbers and reports these measurements to the base station controller. In practice, the mobile station will report on only the six best measurement values and only for those cell frequencies on which that the mobile station can synchronise and consequently receive an identity code relating to the base station (BSIC). The measurement report sent back to the base station controller BSC by the mobile station MS includes a reference to the absolute radio frequency channel numbers ARFCN, the base station identity codes (BSIC) and an indication of the received downlink signal strength. In fact the report does not specify the exact absolute radio frequency channel numbers ARFCN but rather refers to the position this number occupied in the measurement list. On the basis of this report, the base station controller BSC decides whether handover is necessary and to which cell. The initiation of handover is performed according to the standard GSM mechanism for each vendor. Specifically, a message is sent by the base station controller to the mobile services switching center MSC connected to the base station controller BSC indicating that handover is required. This message contains a cell identifier, the cell global identify CGI, which defines the mobile country code (MCC), mobile network code (MNC), location area code (LAC) and cell identity (CI) for the cell to which handover is requested. The cell global identity CGI is fetched by the base station controller from a list using the base station identification code BSIC and absolute radio frequency channel number ARFCN obtained for the cell. With this cell global identity CGI the mobile services switching center MSC is able to determine which other MSC handles the cell defined by the CGI value. For GSM networks that support the General Packet Radio Service GPRS the location of a mobile station must additionally be updated in the GPRS switching nodes SGSN of the core network as the mobile roams between routing areas. Furthermore during active GPRS sessions, the location of the mobile station is updated on cell level in the core network so that the GPRS nodes SGSN send messages towards the correct cells.

Recently proposals have been made to extend conventional cellular networks by including access networks that utilise a low power unlicensed-radio interface to communicate with mobile stations. The access networks are designed to be used together with the core elements of a standard public mobile network. The access network is constructed so that the core elements, such as the mobile switching centers MSC or the GPRS support nodes SGSN, of the public mobile network views the unlicensed-radio access network as a conventional base station controller BSC. Such an access network and the mobile station for use with this access network is described in European patent application No. EP-A-1 207 708. The content of this application is incorporated herein by reference. The low power and resultant low range of the unlicensed-radio interface means that several such access networks may provided in relatively close proximity, for example one access network per floor of an office building. The access network preferably also includes a fixed broadband network which connects to a mobile services switching centre (MSC) of a conventional GSM public mobile network. This greatly facilitates the installation of the access network, permitting a subscriber to install the access network in his own home himself, for example. Suitable unlicensed-radio formats include digital enhanced cordless telecommunications (DECT), wireless LAN and Bluetooth. An adapted mobile handset capable of operating over both the standard air interface (e.g. the Um interface) and the unlicensed-radio interface means that the subscriber requires only one phone for all environments.

The problem when including one or more unlicensed-radio access networks in a conventional public licensed mobile network such as a GSM, UMTS or CDMA2000 network is that handover from the public licensed mobile network to the unlicensed-radio access network greatly increases the necessary operational and maintenance measures required in some cases to unacceptably high levels. Depending on the number of unlicensed-radio access networks present, the number of access points could amount to thousands or tens of thousands. Defining these access points in the relevant elements of the public licensed mobile network would be a time-consuming and costly task. In addition, several unlicensed-radio access points may be located in the same public licensed mobile network cell. The low-power access points will typically have a coverage area of between 50 m to 200 m. It may thus not be possible for the base station controller to compile a list of all possible frequencies that require measurement within the cell in addition to those of the cells adjacent the public licensed mobile network. Moreover, the constraints of the update procedure in the General Packet Radio Service GPRS would mean that at least for the GPRS nodes SGSN, it must be possible to locate a mobile station on cell level. While the cells defined for the purspose of the GPRS interface need not coincide with the mini-cells generated by the access points of an unlicensed-radio access network, each unlicensed radio access network will nevertheless contain more than one GPRS cell.

### SUMMARY OF THE INVENTION

It is thus an object of the present invention to propose a system of handling cells in an unlicensed radio access network that supports packet services over conventional licensed mobile network, such as GSM, UTMS or CDMA2000.

This object is achieved in an access network adapted to communicate with a mobile terminal and packet service nodes in a core network portion of a mobile telecommunications network in accordance with the present invention.

The access network comprises a plurality of local base stations each defining a mini-cell and adapted to communicate with mobile terminals located in a respective mini-cell over an unlicensed-radio interface. An access network controller is connected to the plurality of local base stations and also to a packet service node in the core network portion. The access network controller communicates with the packet service node over a predetermined licensed mobile network interface (the Gb-interface for General Packet Radio Service used in a GSM network). In accordance with the invention, the mini-cells are also grouped into at least two packet service cells, in other words, the access network controller controls a number of mini-cells, which are further grouped into larger packet service cells. The local base stations that generate these mini-cells are assigned a cell identifier. The cell identifier comprises a first identifier portion that is common for all local base stations connected to the access network controller. A second identifier portion comprised in the cell identifier is different for local base stations in different packet service cells but common for all local base stations in the same packet service cell.

In this way, not all local base stations have to have a unique cell identifier. The number of unique identifiers depends on the number of packet service cells controlled by a single access network controller.

Preferably the access network controller is adapted to communicate to the packet service node location update messages from mobile stations containing first and second identifier portions of a cell identifier. In this way, there is no need to configure the packet service nodes with the unique identifiers in advance. The packet service nodes will receive the required identifier when this is necessary following a location update from a mobile that is conducting an active packet service session, such as accessing the Internet.

In a particularly preferred embodiment, the core network comprises a plurality of voice switching nodes, wherein the access network controller is connected to one voice switching node, and only the first identifier portion is configured in the voice switching nodes in the core network portion. In other words, for the voice switching portion of the core network all mini-cells of the unlicensed radio access network have the same identifier and consequently will be viewed as a single cell.

For handover, the access network controller is adapted to receive a handover request from the voice switching node connected thereto, wherein the handover request contains only the first identifier portion of said cell identifier. This greatly simplifies the installation load on the network when an unlicensed access network is installed or new local base stations are added. All local base stations are viewed by the voice switching portion of the core network as a single base station forming a single coverage cell.

### BRIEF DESCRIPTION OF THE DRAWINGS

Further objects and advantages of the present invention will become apparent from the following description of the preferred embodiments that are given by way of example with reference to the accompanying drawings. In the figures:

FIG. 1 schematically depicts parts of a GSM network with an unlicensed-radio access network,

FIG. 2 schematically depicts a cell handling scheme within the unlicensed-radio access network of FIG. 1,

FIG. 3 schematically illustrates the structure of a cell identifier.

### DETAILED DESCRIPTION OF THE DRAWINGS

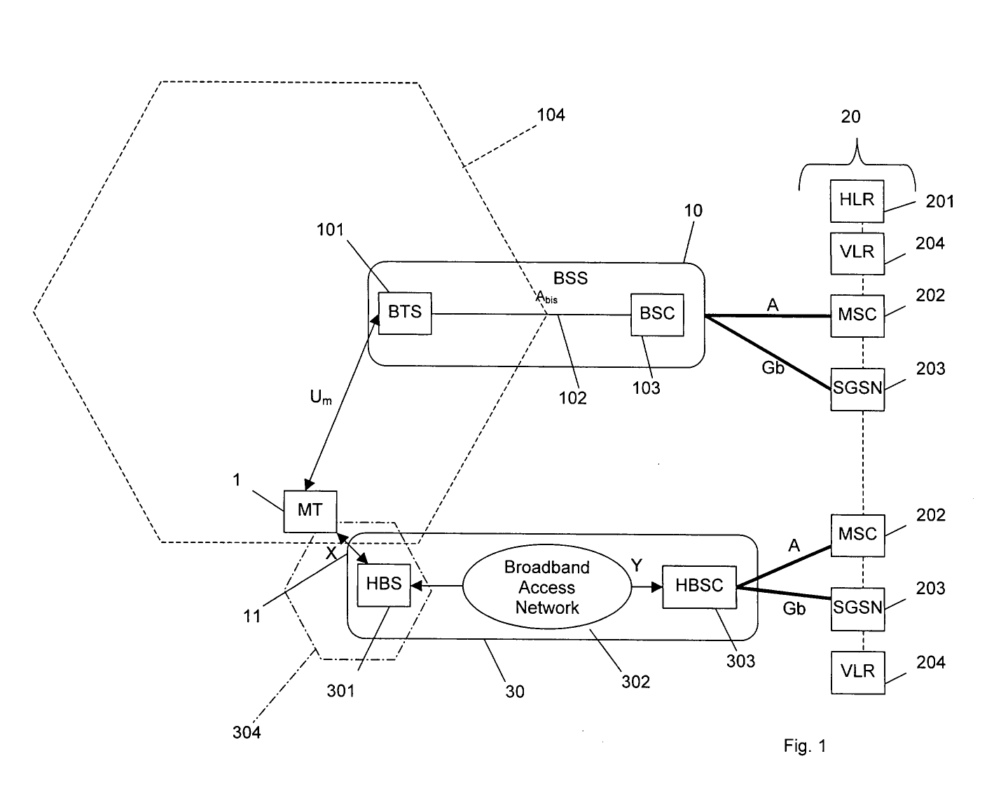

FIG. 1 schematically depicts parts of a conventional GSM network that supports the packet service, General Packet Radio Service GPRS. This network is essentially divided into a core network portion 20 and an access portion 10. The elements of the core network illustrated in the figure include the mobile switching centers or MSCs 202, associated home location register HLR 201 and visitor location register VLR 204. The function and structure of these conventional voice switching GSM architecture elements are known to those in the art and will not be described in further detail here. The core network also supports the General Packet Radio Service (GPRS), and to this end serving GPRS support nodes (SGSN) 203 are illustrated. Although not shown in the figure, it will be understood by those skilled in the art that the core network portion may include access to other mobile and fixed-line networks, such as ISDN and PSTN networks, packet and circuit switched packet data networks such as intranets, extranets and the Internet through one or more gateway nodes.

The access portion essentially consists of base station subsystems BSS 10, one of which is illustrated in FIG. 1, which communicate via defined fixed standard A and Gb interfaces with MSCs 202 and SGSNs 203, respectively, in the core network portion 20. Each base station subsystem BSS 10 includes a base station controller BSC 103 which communicates with one or more base transceiver stations BTS 101 via the defined A_{biS} air interface 102. The base transceiver stations 101 communicate with mobile terminals MT 1 over the GSM standard Uₘ radio air interface. It will be understood that while the BTS 101 and BSC 103 are depicted as forming a single entity in the BSS 10, the BSC 103 is often separate from the BTSs 101 and may even be located at the mobile services switching centre MSC 202. The physical division depicted in FIG. 1 serves to distinguish between the parts of the network making up the access network portion 10 and those that form the core network portion 20.

In addition to the standard access network portion provided by the BSS's 10 the network depicted in FIG. 1 further includes a modified access network portion 30 shown in the lower half of the figure. Hereinafter this will be described as an unlicensed-radio access network portion.

The components making up this unlicensed-radio access network portion 30 also enable the mobile terminal 1 to access the GSM core network portion, and through this, other communication networks via an unlicensed-radio interface X, represented in FIG. 1 by the bi-directional arrow 31. By unlicensed-radio is meant any radio protocol that does not require the operator running the mobile network to have obtained a license from the appropriate regulatory body. In general, such unlicensed-radio technologies must be low power and thus of limited range compared to licensed mobile radio services. This means that the battery lifetime of mobile terminals will be greater. Moreover, because the range is low the unlicensed-radio may be a broadband radio, thus providing improved voice and data quality. The radio interface may utilise any suitable unlicensed-radio protocol, for example a wireless LAN protocol or Digital Enhanced Cordless Telecommunications (DECT). Preferably, however, Bluetooth radio is utilised, which has a high bandwidth and lower power consumption than conventional public mobile network radio.

The Bluetooth standard specifies a two-way digital radio link for short-range connections between different devices. Devices are equipped with a transceiver that transmits and receives in a frequency band around 2.45 GHz. This band is available globally with some variation of bandwidth depending on the country. In addition to data, up to three voice channels are available. Each device has a unique 48-bit address from the IEEE 802 standard. Built-in encryption and verification is also available.

The element of the fixed access network portion 30 adapted to communicate across the Bluetooth interface is designated a local or home base station (HBS) 301. This element handles the radio link protocols with the mobile terminal MT 1 and contains radio transceivers that define a cell in a similar manner to the operation of a conventional GSM base station transceiver BTS 101. The home base station HBS 301 is controlled by a home base station controller HBSC 303, which communicates with a mobile service switching centre MSC 202 over the GSM standard A interface and also with a serving GPRS support node SGSN 203 over a standard Gb interface. The interface between the home base station HBS 301 and its home base station controller HBSC 303 is designated a Y-interface. The home base station controller HBSC 303 provides the connection between the MSC 202 or SGSN 203 and mobile terminal 1. The joint function of the home base station HBS 301 and the home base station controller HBSC 303 emulates the operation of the BSS 10 towards the SGSN 203 and MSC 202. In other words, when viewed from the elements of the core network 20 such as the mobile service switching centre (MSC) 202 and the serving GPRS support node (SGSN) 203, the fixed access network portion 30 constituted by the home base stations HBS 301 and the home base station controller HBSC 303 looks like a conventional access network portion 10.

The applications that run on the mobile terminal MT 1 on top of the public mobile network radio interfaces also run on top of Bluetooth radio between the mobile terminal 1 and the home base station HBS 301.

The interface between the home base station HBS 301 and the home base station controller HBSC 303 which is designated Y in FIG. 1 is preferably provided by a fixed link. The home base station 301 is intended to be a small device that a subscriber can purchase and install in a desired location such as the home or an office environment to obtain a fixed access to the mobile network. However, they could also be installed by operators in traffic hotspots. In order to reduce the installation costs on the part of the operator, the interface between the home base station 301 and the home base station controller 303, which is designated interface Y in FIG. 1 therefore preferably exploits an already existing connection provided by a fixed network 302. Preferably this network is a broadband packet network. Suitable networks might include those based on ADSL, Ethernet, LMDS, or the like. Home connections to such networks are increasingly available to subscribers. Although not shown in FIG. 1, the home base station HBS 301 will be connected to a network terminal giving access to the fixed network 302, while the home base station controller HBSC 303 may be connected to an edge router ER of the network 302 that also links the fixed network 302 to other networks such as intranets and the internet. The Internet Protocol IP is used for communication between the home base station HBS 301 and home base station controller HBSC 303 over the fixed network 302 to render the transport of data independent of the network type. The link between the home base station HBS 301 and the home base station controller HBSC 303 is preferably always open, so that this connection is always available without the need for reserving a channel. While the fixed network 302 is preferably an IP-based network, ATM-based networks could also be used. In particular when DSL technologies are used in this network, they could be used directly on top of the ATM layer, since they are based on ATM. Naturally, an ATM based network could also be used to transport IP, serving as a base layer.

The home base station HBS 301 is installed by plugging it in to a port of a suitable modem, such as an ADSL or CATV modem, to access the fixed network 302. The port is in contact with an intranet that is either bridged or routed on the IP level. Thus standard protocols, such as IP, DHCP, DNS and the like are used. The home base station HBS 301 connected to the modem utilises these standard protocols and functions to ascertain to which home base station controller HBSC 303 it should connect, and also to establish a connection with this home base station controller HBSC 303.

The base stations 101 and 301 in both the conventional access network 10 portion and the unlicensed-radio access network portion 30 define a coverage area for voice traffic depicted in FIG. 1 by hexagonal cells 104, 304. While the relative dimensions of these cells are not accurate in the figure, it is nevertheless clear that the coverage of a conventional BTS 101 is far greater than the comparatively low power HBS 301. The coverage area of a home base station 301 will typically between about 50 m and 200 m. For this reason, and because an HBS 301 can be installed wherever there is a port to the fixed broadband network connected to an HBSC 303, one or more mini-cells 304 generated by HBS's 301 may be located inside the cell 104 of a conventional BTS 101.

In a conventional GSM network, handover of calls between adjacent cells is enabled by informing the currently connected access network 10 and the core network portion 20 of the identification of neighbouring cells by means of a cell global identity CGI, which contains the mobile country code, mobile network code, cell identity (CI) and a location area code, and also providing information about which BSC 103 and MSC 202 or SGSN 203 controls these cells. The BSC 103 must be able to communicate the absolute radio frequency channel numbers (ARFCN) allocated to all neighbouring cells to a mobile terminal 1 connected to it so that the mobile terminal 1 can measure the associated frequencies and report back the strongest frequencies. In addition to the channel number ARFCN, this message also includes a base station identity code BSIC that is unique in the area to the base station transmitting on the identified channel frequency. With the introduction of a large number of mini-cells 304 resulting from the installation of an unlicensed-radio access network 30 this kind of operation and maintenance activity becomes very complex and cumbersome, particularly as the location of the mini-cells may change over time.

In addition to the need for the core network 20 to be configured with the identity and controlling nodes of neighbouring cells the location of a mobile station that is active in a GPRS session must also be updated as it roams through different cells. This is also known as the GPRS READY-STATE in GMM. In this case by means of GPRS mobility management (GMM) messages (an LLC-PDU) sent to the corresponding peer layer in the GPRS support node SGSN (203) as the mobile station moves from one cell to a neighbouring cell. In a GSM network the cells for GPRS correspond to the GSM cells 104. However, in some systems the Gb-interface has a limited capacity. If this capacity might be exceeded a new GPRS cell must be defined.

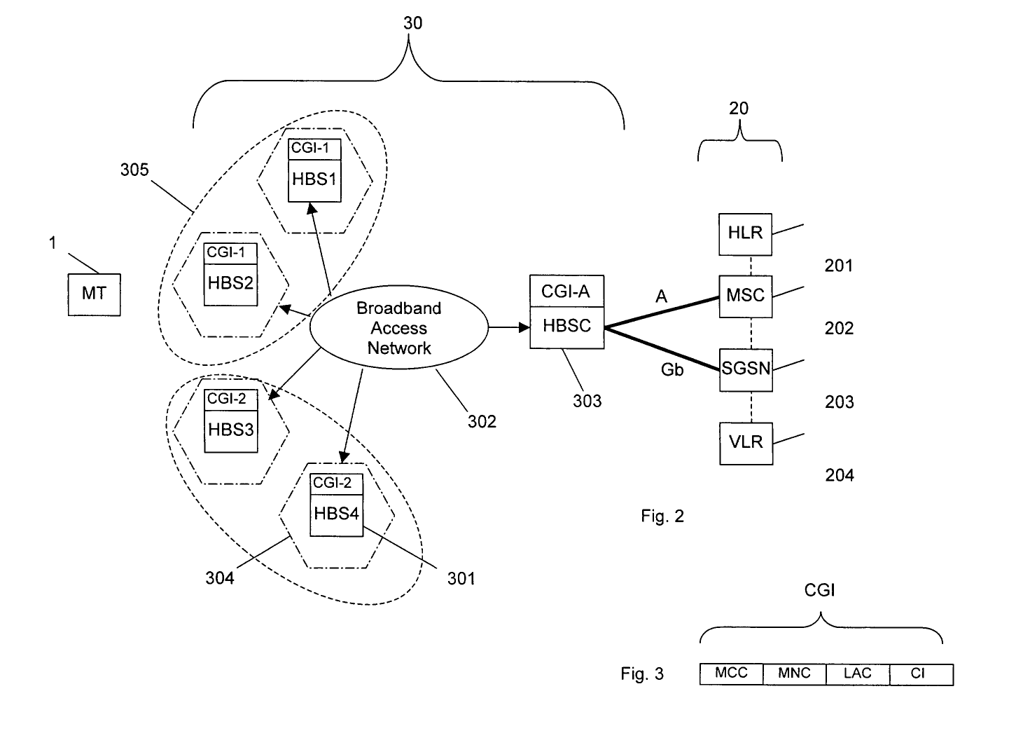

FIG. 2 illustrates how cells in an unlicensed-radio access network can be handled and defined in order to reduce the configuration load on installation yet still preserve the normal functionality for both GSM and GPRS on the part of the core network portion 20.

FIG. 2 illustrates an unlicensed-radio access network as shown in FIG. 1 with the core network portion 20 likewise illustrated in FIG. 1. Like reference numerals have been used for like parts in both figures, so a renewed description of these will not be repeated.

In the unlicensed-radio access network 30, the home base station controller HBSC 303 controls several home base stations HBS 301. This is exemplified in FIG. 2 by the depiction of four HBS1, HBS2, HBS3, HBS4 301. The home base stations HBS 301, and thus the mini-cell 304 generated thereby in the same access network 30 may be located close to one another or at a great distance from one another depending on the available access to the broadband access network 203.

In addition to the mini-cells 304, which are generated by each home base station HBS 301, the home base stations are further grouped into subgroups 305. In the illustrated embodiment, two home base stations HBS 301 are shown in the same subgroup, however, in practice, a subgroup 305 could contain 1000 home base stations HBS 301 and mini-cells 304. This subgrouping corresponds essentially to the capacity limitations of the Gb-interface. This means that each subgroup 305 essentially defines a packet service cell.

While in a conventional GSM network each cell 104 has a unique identity that is configured in the network, in order to reduce the configuration load when installing or modifying the unlicensed radio access network a single cell identifier is assigned firstly to the home base station controller HBSC 303. This identifier is shown as CGI-A. This identifier is used for configuration of the core network and conventional access networks to enable handover, etc. In other words, when handover from a GSM cell 104 to an unlicensed-radio access network mini-cell 304 is required, the information broadcast by the home base station HBS 301 controlling the cell and transmitted to the core network by the mobile station 1 indicates this home base station controller HBSC 303. The home base station controller HBSC 303 then must identify the mini-cell concerned, for example by matching a handover reference allotted to the handover request with a message received by the home base station HBS 301 concerned.

Within the access network itself, the mini-cells in each subgroup 305 are assigned common cell identifier that is different from that identifying the home base station controller and also different from that identifying the other subgroups 305. The cell identifier used to identify cells is equivalent to a global cell identifier GCI. The structure of the global cell identifier GCI is illustrated in FIG. 3. This consists of four components, a mobile country code (MCC), a mobile network code (MNC), location identity (LI) and cell identity (CI). The mobile country code (MCC), mobile network code (MNC) and location identity (LI) together define a location area which is used, for example, for paging mobile stations. In accordance with the invention, the location area portion of this global cell identifier is the same for all home base stations HBS 301 connected to the home base station controller HBSC 303. In other words, all mini-cells in this access network are in the same location area. However, the cell identity (CI) of the mini-cells 304 depends on which subgroup 305 they are in. All mini-cells 304, and thus all home base stations HBS 301 in the same subgroup 305 have the same cell identity (CI). In this way, in the illustrated access network of FIG. 2, the mini-cells 304 controlled by the home base station controller HBSC (303) have two possible cell identifiers (CGI) CGI-1 or CGI-2 within the access network, with this identifier being composed of a common part and a part that is dependent on subgrouping 305. In practice a home base station controller HBSC 303 could control some tens of subgroups 305.

The cell identifiers CGI-1, CGI-2 of the packet service cells 305 is not configured in the GSM nodes of the core network 20.—These identifiers are used only to permit location updates to be made to the corresponding GPRS node (SGSN) by a mobile station 1 moving from one packet service cell 305 to another when active in a GPRS session. The GPRS node (SGSN) will then know to send messages to the new packet service cell.

As a result of this cell identification within the unlicensed-radio access network 30, the voice-interface components of the core network 20 will view the unlicensed radio access network as a single cell, rather than the many more mini-cells 304 actually present. Only the packet service node SGSN 203 connected to the unlicensed radio access network will be informed dynamically of the cell identifiers for each packet service cell. This can be performed by a message from the home base station controller HBSC 303.

The identifier of the mini-cells 304 are preferably assigned dynamically by the home base station controller HBSC 303 as these connect to the unlicensed radio access network.

This form of cell handling means that the core network views the whole unlicensed access network as a single cell identified by a common cell identifier. Within the access network itself, mini-cells 304 have a further identifier that is unique to a specific packet service group or cell. This unique identifier is used only for communicating location updates in an active packet service session and in that case is communicated dynamically by the home base station controller HBSC 303. However, this unique identifier does not need to be configured in the GSM network.

The unlicensed-radio access network 30 described with reference to the figures resembles a conventional access network in that there are a plurality of base station elements with their own functionality and a controller connected to these base stations. However, the present invention is not limited to this structure. In an alternative embodiment the same operation is achieved with an essentially transparent access point, that is existing access points to a broadband network, by transferring the functionality of the home base stations to the home base station controller and/or the mobile station. In other words, the mobile station communicates directly with the home base station controller HBSC 303 over an unlicensed-radio interface and the broadband network via the access point.

The above detailed description of cell handling has referred only to unlicensed radio access networks of GSM networks as a conventional public mobile network. It will be understood by those skilled in the art, however, that handover from other conventional public mobile networks, such as UMTS or CDMA2000, to an unlicensed-radio access network can be handled in an analogous manner. In all cases, the allocation of a limited number of cell identifiers for a whole unlicensed-radio access network and the subsequent handling within the unlicensed-radio access network would be applicable for other technologies.

1. An access network adapted to communicate with a mobile terminal and packet service nodes in a core network portion of a mobile telecommunications network, said access network comprising:
a plurality of local base stations each defining a mini-cell and adapted to communicate with mobile terminals located in a respective mini-cell over an unlicensed-radio interface; and
an access network controller connected to a packet service node in said core network portion and adapted to communicate with said packet service node over a predetermined licensed mobile network interface, and connected to said plurality of local base stations;
said mini-cells being grouped into at least two packet service cells with at least two mini-cells in each packet service cell and said local base stations being assigned a cell identifier comprising a first identifier portion that is common for all local base stations connected to said access network controller and a second identifier portion that is common for all local base stations in the same packet service cell but different for local base stations in different packet service cells.

2. An access network as claimed in claim 1, wherein said access network controller is assigned a cell identifier comprising said first identifier.

3. An access network as claimed in claim 1 wherein said access network controller is adapted to communicate to said packet service node location update messages from mobile stations containing first and second identifier portions of a cell identifier.

4. An access network as claimed in claim 1 wherein said core network comprises a plurality of voice switching nodes, wherein said access network controller is connected to one voice switching node, and only said first identifier portion is configured in said voice switching nodes in the core network portion.

5. An access network as claimed in claim 4. wherein said access network controller is adapted to receive a handover request from the voice switching node connected thereto, wherein said handover request contains only said first identifier portion of said cell identifier.

6. An access network as claimed in claim 1 wherein said local base stations are adapted to communicate said cell identifier to mobile terminals in said mini-cells.

7. An access network as claimed in claim 1 further comprising a fixed broadband network connecting said plurality of local base stations with said access network controller.

8. An access network as claimed in claim 1 wherein said cell identifiers are dynamically assigned to said mini-cells by said access network controller.

9. A method of utilizing an access network for communicating with a mobile terminal and packet service nodes in a core network portion of a mobile telecommunications network, the method comprising:
communicating over an unlicensed radio interface with mobile terminals located in a mini-cell, the mini-cell comprising a plurality of local base stations and
utilizing an access network controller connected to a packet service node in the core network portion for communicating with the packet service node over a predetermined licensed mobile network interface, the access network controller also connected to the plurality of local base stations,
the mini-cells being grouped into at least two packet service cells with at least two mini-cells in each packet service cell and the local base stations being assigned a cell identifier comprising a first identifier portion that is common for all local base stations connected to the access network controller and a second identifier portion that is common for all local base stations in the same packet service cell but different for local base stations in different packet service cells.

10. The method as claimed in claim 9, wherein the access network controller is assigned a cell identifier comprising the first identifier.

11. The method as claimed in claim 9 wherein the access network controller is adapted to communicate to the packet service node location update messages from mobile stations containing first and second identifier portions of a cell identifier.

12. The method as claimed in claim 9, wherein the core network comprises a plurality of voice switching nodes, the access network controller is connected to one voice switching node, and only the first identifier portion is configured in the voice switching nodes in the core network portion.

13. The method as claimed in claim 12, the access network controller receiving a handover request from the voice switching node connected thereto, wherein the handover request contains only the first identifier portion of the cell identifier.

14. The method as claimed in claim 9 wherein the local base stations communicating the cell identifier to mobile terminals in the mini-cells.

15. The method as claimed in claim 9 further comprising connecting the plurality of local base stations with the access network controller via a fixed broadband network.

16. The method as claimed in claim 9 further comprising dynamically assigning the cell identifiers to the mini-cells by the access network controller.
